(19) United States
(12) Patent Application Publication
(10) Pub. No.: US 2018/0343081 A1
(43) Pub. Date: Nov. 29, 2018

(54) TRANSMITTING COMMUNICATION DEVICE, RECEIVING COMMUNICATION DEVICE AND METHOD PERFORMED THEREIN COMPRISING MAPPING THE CONSTELLATION SYMBOLS

(71) Applicant: Telefonaktiebolaget LM Ericsson (publ), Stockholm (SE)

(72) Inventor: Miguel LOPEZ, SOLNA (SE)

(21) Appl. No.: 15/778,655

(22) PCT Filed: Dec. 16, 2015
(86) PCT No.: PCT/SE2015/051353

§ 371 Date: May 24, 2018

(51) Int. Cl. H04L 1/00; H04L 5/00; H04L 27/26; H04L 25/03

(52) U.S. Cl. CPC H04L 1/0003; H04L 5/0083; H04L 2025/03414; H04L 5/0012; H04L 25/03006; H04L 27/2604

(57) ABSTRACT

Embodiments herein relate to a method performed by a transmitting communication device for transmitting data to a receiving communication device in a communication network supporting multicarrier modulation. The transmitting communication device applies, to the data, a modulation and coding scheme forming constellation symbols. The transmitting communication device maps the constellation symbols to radio resources of a first multicarrier symbol and to radio resources of a second multicarrier symbol. The first and second multicarrier symbols are consecutive multicarrier symbols. The transmitting communication device refrains from mapping a constellation symbol to a first radio resource of the first multicarrier symbol having a same sub-carrier center of frequency as a second radio resource of the second multicarrier symbol with a mapped constellation symbol. The transmitting communication device transmits the first multicarrier symbol and the second multicarrier symbol to the receiving communication device.

### TECHNICAL FIELD

Embodiments herein relate to a transmitting communication device, a receiving communication device, and methods performed therein for wireless communication. Furthermore, a computer program and a computer readable storage medium are also provided herein. In particular, embodiments herein relate to transmitting data to the receiving communication device in a communication network.

### BACKGROUND

In a typical communication network, wireless devices, also known as wireless communication devices, mobile stations, stations (STA) and/or user equipments (UE), communicate via a Radio Access Network (RAN) to one or more core networks. The RAN covers a geographical area which is divided into service areas or cell areas, with each service area or cell area being served by a radio network node such as a radio access node e.g., a WiFi access point or a radio base station (RBS), which in some networks may also be denoted, for example, a “NodeB” or “eNodeB”. The service area or cell area is a geographical area where radio coverage is provided by the radio network node. The radio network node communicates over an air interface operating on radio frequencies with the wireless device within range of the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for e.g. third generation (3G) networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs are typically connected to one or more core networks.

Specifications for the Evolved Packet System (EPS), also called as Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as a radio access network of a Long Term Evolution (LTE) network, and the Evolved Packet Core (EPC), also known as System Architecture Evolution (SAE) core network. E-UTRAN/LTE is a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Furthermore, systems today may also use 802.11 standard for communication, also denoted WiFi systems, wherein wireless devices communicate with an access-point or access controller such as a wireless router or similar, which wireless device may be referred to as 802.11 devices, WiFi devices, or wireless device with WiFi capability.

As usage of wireless devices with a need to communicate are growing also applications for these wireless devices are growing. These applications may be referred to as Internet on Things (IoT) applications or applications for IoT. IoT is a term used for a wide variety of devices such as sensors, implants, and vehicles with built-in sensors, just to mention some examples. These devices collect useful data using various communication technologies, e.g. WiFi, and the data may also flow between other devices. The WiFi community has realized that conventional broadband WiFi systems are not ideally suited for IoT applications. It is important to note that energy efficiency and long range are of paramount importance in many IoT applications. For these reasons, a new 802.11ah standard has been developed. It employs relatively narrow radio frequency channels, e.g. 1-2 MHz, in unlicensed subbands of 1 GHz. In addition, there have been proposals in the 802.11 IEEE standardization group to introduce narrower radio frequency channels, such as 2 MHz, in the 2.4 GHz unlicensed band, in order to cater for IoT applications. These proposals are currently under discussion under the name of Low Power Long Range (LPLR).

The design of the 802.11ah air interface was clearly guided by the principle of re-use of hardware and software, to make it compatible with earlier versions of the standard 802.11. Backwards compatibility accelerates time to market and reduces costs. As an example, 802.11ah inherited all the Modulation and Coding Schemes (MCS) from 802.11ac, which enables the re-use of hardware accelerators that perform Viterbi decoding. Similarly, the current proposal for an enhancement of the 802.11 standard in the 2.4 GHz bands mentions compatibility with the 802.11ax standard.

Range extension in 802.11ah is obtained by simple methods that are to a large extent backward compatible with previous versions of the standard. In addition to using sub 1 GHz carrier frequencies, 802.11ah employs the following methods.
Narrow radio frequency channels, which allow a transmitter to increase the power spectral density. The narrowest channel bandwidth in 802.11ah is 1 MHz.
2X repetition code. A new MCS named MCS10 is created starting from MCS0, which is the most robust MCS inherited from 802.11ac, and adding a 2X repetition code. In theory, the range is increased by 3 dB, at the cost of doubling the length of the packets and doubling the energy consumption. It should be noted that the design of MCS10 has the merit of simplicity and that it follows the principles mentioned above regarding the reuse of the hardware and software.

As stated above achieving communication of long range is very important in many IoT applications. In 802.11ah the longest range is achieved using MCS10, which is based on MCS0 plus a 2X repetition code. A similar MCS design focusing on range extension could be used in a new version of 802.11 in the 2.4 GHz band.

Thus, in an ordinary Orthogonal frequency-division multiplexing (OFDM) communications system such as 802.11ac or 802.11ah the user data is first coded using a channel code, modulated to Phase Shift Keying (PSK)/Quadrature amplitude modulation (QAM) symbols, being examples of constellation symbols, and then mapped to consecutive OFDM symbols. A series of consecutive OFDM symbols is called a packet. OFDM systems often append a cyclic prefix to each OFDM symbol to take care of time discrepancies of receiving echoed versions of the packet, and in the case of 802.11 systems, a preamble is also appended at the beginning of the packet. An example is shown in the time-frequency diagram shown in FIG. 1a. Frequencies or sub-carriers are defined along a vertical axis and time is defined along a horizontal axis in a time-frequency diagram. The available radio resources are divided into rectangles, representing a time-frequency allocation. A single time-frequency resource, determined by the sub-carrier spacing and the OFDM symbol, plus overhead, e.g. cyclic prefix, duration, will be called simply a radio resource. For example, in FIG. 1a the payload is allocated to a total of 24 radio resources. More generally, the time and frequency plane can be partitioned into blocks consisting of a group of one or more sub-carriers for a specific time duration. In FIG. 1a, depicting mapped data to a first OFDM symbol #1 and a second OFDM symbol #2, the preamble of the packet is marked with a dotted pattern and radio resources with mapped constellation symbols or data are darkly marked and CPs added to the constellation symbols are marked with a diagonal striped pattern.

The 802.11ah standard employs a 2X repetition code to providing a more robust MCS. The information bits are coded according to an existing channel code, and then each code bit is repeated. The mapping to PSK modulation symbols and finally to OFDM symbols proceeds as in the original MCS. The result of applying this methodology to the packet of FIG. 1a is illustrated in the time-frequency diagram of FIG. 1b. Frequencies or sub-carriers are defined along a vertical axis and time is defined along a horizontal axis. Note that the length of the payload has been doubled with respect to FIG. 1a. In FIG. 1b the data with a repetition code are mapped to four OFDM symbols instead of two OFDM symbols, OFDM symbol #1-OFDM symbol #4.

A problem with the MCS10 design is that packets are roughly twice as long as MCS0 packets, which means that twice the energy is consumed when transmitting or receiving such packets, in comparison with MCS0 packets. Since the radio channel is relatively narrow, such as 1 MHz, the packets have a long duration in time, up to approx. 28 ms. The link performance degrades as the packet length increases, especially for time varying propagation channels, such as those found in outdoor deployments. Hence, doubling the length of a packet is wasteful, increases the occupancy of the channel medium and leads to diminished gains in time varying radio channels and limited performance of the communication network.

### SUMMARY

An object of embodiments herein is to provide a mechanism for improving performance of the communication network in an efficient manner.

According to an aspect the object is achieved by a method performed by a transmitting communication device for transmitting data to a receiving communication device in a communication network supporting multicarrier modulation. The transmitting communication device applies, to the data, a modulation and coding scheme forming constellation symbols. The transmitting communication device maps the constellation symbols to radio resources of a first multicarrier symbol and to radio resources of a second multicarrier symbol, wherein the first and second multicarrier symbols are consecutive multicarrier symbols. The mapping comprises refraining from mapping a constellation symbol to a first radio resource of the first multicarrier symbol having a same sub-carrier center of frequency as a second radio resource of the second multicarrier symbol with a mapped constellation symbol. The transmitting communication device transmits the first multicarrier symbol and the second multicarrier symbol to the receiving communication device.

According to another aspect the object is achieved by a method performed by a receiving communication device for receiving data from a transmitting communication device in a communication network supporting multicarrier modulation. The receiving communication device obtains a modulation and coding scheme indication, indicating that constellation symbols are mapped to radio resources of a first multicarrier symbol and to radio resources of a second multicarrier symbol. The first and second multicarrier symbols are consecutive multicarrier symbols, and a constellation symbol is not mapped to a first radio resource of the first multicarrier symbol having a same sub-carrier center of frequency as a second radio resource of the second multicarrier symbol with a mapped constellation symbol. The receiving communication device receives, from the transmitting communication device, the first multicarrier symbol and the second multicarrier symbol; and decodes the received first and second multicarrier symbols based on the received modulation and coding scheme indication.

According to yet another aspect the object is achieved by providing a transmitting communication device for transmitting data to a receiving communication device in a communication network supporting multicarrier modulation. The transmitting communication device is configured to apply, to the data, a modulation and coding scheme forming constellation symbols. The transmitting communication device is further configured to map the constellation symbols to radio resources of a first multicarrier symbol and to radio resources of a second multicarrier symbol, wherein the first and second multicarrier symbols are consecutive multicarrier symbols. The transmitting communication device is also configured to refrain from mapping a constellation symbol to a first radio resource of the first multicarrier symbol having a same sub-carrier center of frequency as a second radio resource of the second multicarrier symbol with a mapped constellation symbol. The transmitting communication device is further configured to transmit, to the receiving communication device, the first multicarrier symbol and the second multicarrier symbol.

According to still another aspect the object is achieved by providing a receiving communication device for receiving data from a transmitting communication device in a communication network supporting multicarrier modulation. The receiving communication device is configured to obtain a modulation and coding scheme indication, indicating that constellation symbols are mapped to radio resources of a first multicarrier symbol and to radio resources of a second multicarrier symbol, wherein the first and second multicarrier symbols are consecutive multicarrier symbols. A constellation symbol is not mapped to a first radio resource of the first multicarrier symbol having a same sub-carrier center of frequency as a second radio resource of the second multicarrier symbol with a mapped constellation symbol. The receiving communication device is further configured to receive, from the transmitting communication device, the first multicarrier symbol and the second multicarrier symbol. The receiving communication device is also configured to decode the received first and second multicarrier symbols based on the received modulation and coding scheme indication.

It is furthermore provided herein a computer program comprising instructions, which, when executed on at least one processor, cause the at least one processor to carry out any of the methods above, as performed by the transmitting communication device or the receiving communication device. It is additionally provided herein a computer-readable storage medium, having stored thereon a computer program comprising instructions which, when executed on at least one processor, cause the at least one processor to carry out the method according to any of the methods above, as performed by the transmitting communication device or the receiving communication device.

Hence, refraining from mapping the constellation symbol to the first radio resource of the first multicarrier symbol having the same sub-carrier center of frequency as the second radio resource of the second multicarrier symbol with a mapped constellation symbol, wherein the first and second multicarrier symbols are consecutive multicarrier symbols, enables the transmitting communication device to transmit the constellation symbols with a power that is increased compared to transmit the constellation symbols using a legacy MCS with a repetition code, e.g. MCS10. Furthermore, this enables a transmission with no need of inserting cyclic prefix to the multicarrier symbol and thus some embodiments herein result in that the packet is shorter, compared to using repetition code of multicarrier symbols with CP, leading to a reduced time the transmitting communication device is occupying a communication channel for the transmission. Thus, embodiments herein improve performance of the communication network in an efficient manner.

### BRIEF DESCRIPTION OF THE DRAWINGS

Embodiments will now be described in more detail in relation to the enclosed drawings, in which:

FIG. 1a is a schematic example of time-frequency radio resource allocation in a multicarrier system according to prior art);

FIG. 1b is a schematic example of time-frequency radio resource allocation in a multicarrier system according to prior art;

FIG. 2 is a schematic overview depicting a communication network according to embodiments herein;

FIG. 3 is a schematic flowchart depicting a method performed by a transmitting communication device according to embodiments herein;

FIG. 4 is a schematic flowchart depicting a method performed by a receiving communication device according to embodiments herein;

FIG. 5a is a combined flowchart and signalling scheme according to embodiments herein;

FIG. 5b is a combined flowchart and signalling scheme according to embodiments herein;

FIG. 6 is a block diagram depicting a transmitting communication device according to embodiments herein;

FIG. 7 is a diagram depicting mapping of constellation symbols according to embodiments herein;

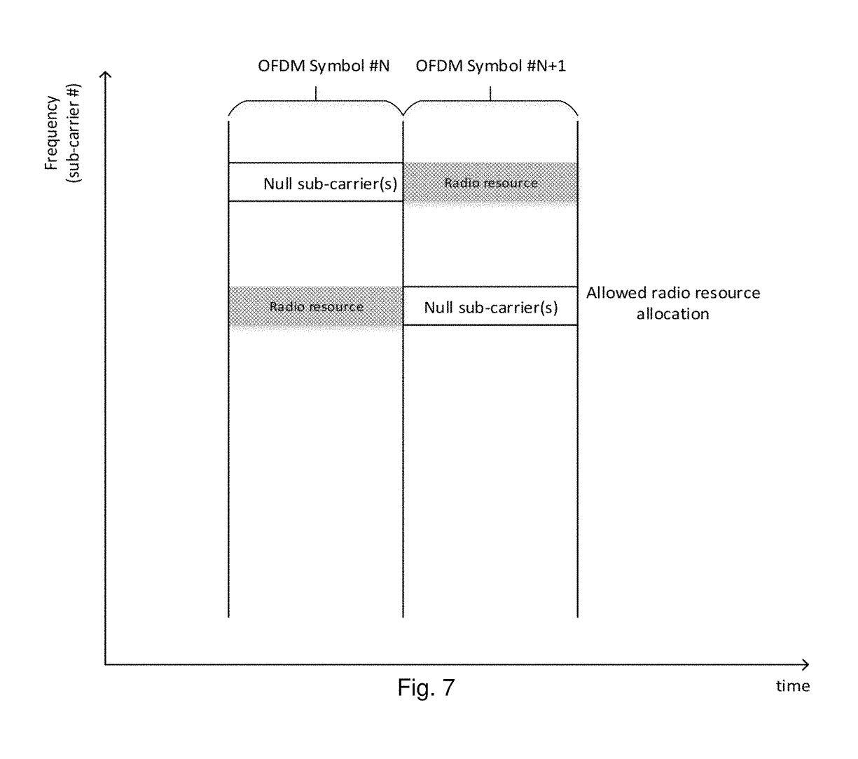

FIG. 8 is a diagram depicting mapping of constellation symbols according to embodiments herein;

FIG. 9 is a diagram depicting mapping of constellation symbols according to embodiments herein;

FIG. 10 is a diagram comparing outcome of using embodiments herein and using conventional MCS10;

FIG. 11 is a diagram comparing outcome of using embodiments herein and using conventional MCS10;

FIG. 12 is a block diagram depicting a transmitting communication device according to embodiments herein; and

FIG. 13 is a block diagram depicting a receiving communication device according to embodiments herein.

### DETAILED DESCRIPTION

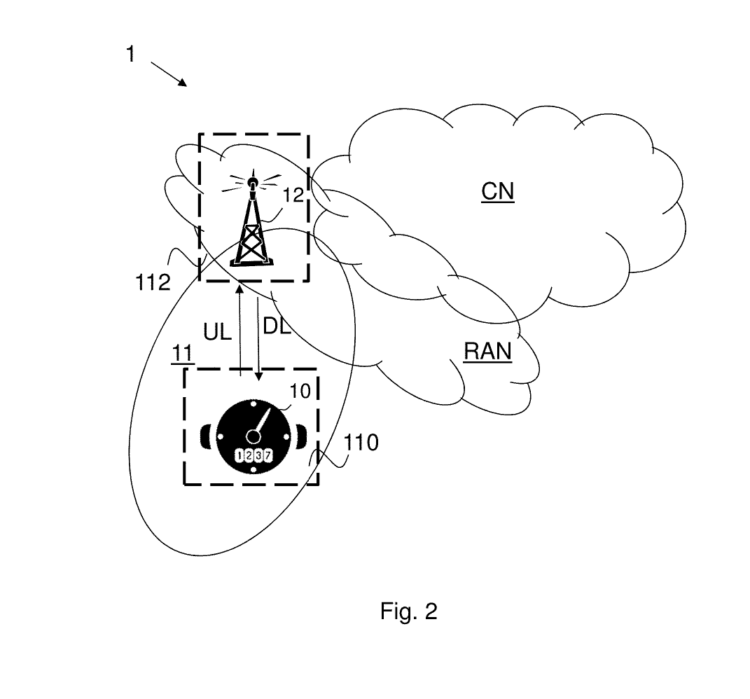

Embodiments herein relate to communication networks in general. FIG. 2 is a schematic overview depicting a communication network 1. The communication network 1 comprises one or more RANs and one or more CNs. The communication network 1 may use a number of different technologies, such as WiFi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends such as a 5G networks, using Wi-Fi, however, embodiments are applicable also in further development of the existing communication systems such as e.g. WCDMA and LTE.

In the communication network 1, wireless devices e.g. a wireless device 10 such as a mobile station, a non-access point (non-AP) STA, a STA, a user equipment and/or a wireless terminals, communicate via one or more Access Networks (AN), e.g. RAN, to one or more core networks (CN). It should be understood by those skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a base station communicating within a cell. The wireless device 10 is exemplified herein as a MTC device requiring longer range of transmissions.

The communication network 1 comprises a radio network node 12 providing radio coverage over a geographical area, a first service area, of a first radio access technology (RAT), such as LTE, Wi-Fi or similar. The radio network node 12 may be a radio access network node such as radio network controller or an access point such as a WLAN access point or an Access Point Station (AP STA), an access controller, a base station, e.g. a radio base station such as a NodeB, an evolved Node B (eNB, eNodeB), a base transceiver station, Access Point Base Station, base station router, a transmission arrangement of a radio base station, a stand-alone access point or any other network unit capable of serving a wireless device within the service area served by the radio network node 12 depending e.g. on the first radio access technology and terminology used.

In the communication network 1 the radio network node 12 and the wireless device 10 communicates in Uplink (UL) communications from the wireless device 10 to the radio network node 12, and in Downlink (DL) communications to the wireless device 10 from the radio network node 12. Thus, the wireless device 10 may in some scenarios be a transmitting communication device 110 and in some scenarios a receiving communication device 112. Similarly, the radio network node 12 may in some scenarios be the receiving communication device 112 and in some scenarios be the transmitting communication device 110.

Embodiments herein disclose a method to make communication more robust than using an existing MCS in a multi-carrier system. For the sake of concreteness the description below focuses on OFDM, but the principles described herein are generally applicable to any multicarrier systems, e.g. Filter Bank Multicarrier systems. According to embodiments herein the transmitting communication device 110 applies, to the data, a modulation and coding scheme forming constellation symbols. The transmitting communication device 110 maps the constellation symbols to radio resources of a first multicarrier symbol and to radio resources of a second multicarrier symbol. The first and second multicarrier symbols are consecutive multicarrier symbols. The transmitting communication device 110 refrains from mapping the constellation symbols to a first radio resource of the first multicarrier symbol having a same sub-carrier center of frequency as a second radio resource of the second multicarrier symbol with a mapped constellation symbol. The transmitting communication device 110 then transmits the first multicarrier symbol and the second multicarrier symbol. In embodiments herein the transmitting communication device 110 hence decimates the radio resources such as sub-carriers or time-frequency resources, available for data in both time and frequency, while enabling that a power assigned to the remaining radio resources may be boosted.

Thus, embodiments herein disclose a new design of a robust MCS. Embodiments herein may be seen as an alternative design to the robust MCS10 in 802.11ah. Decimation in time means that some radio resources are removed in some multicarrier symbols, e.g. OFDM symbols, but not in other multicarrier symbols. A decimation pattern may be chosen so that a cyclic prefix is not needed. As an example, an MCS as robust as MCS10 can be obtained from MCS0 by decimating the available sub-carriers in a “chess-board” pattern or checkered pattern. E.g. even numbered sub-carriers are nulled in even numbered OFDM symbols, while odd numbered sub-carriers are nulled in odd numbered OFDM symbols. This reduces the number of available data sub-carriers by a factor of two. Hence, the power of the remaining sub-carriers can be boosted by 3 dB, giving a gain comparable to that of a repetition code. Since the number of data sub-carriers available for mapping is halved, the number of OFDM symbols must be doubled, in order to accommodate the constellations symbols such as MCS0 coded Binary Phase Shift Keying (BPSK) modulated symbols. However, since no cyclic prefix is required, the packet is 25% shorter than an MCS10 packet carrying the same payload.

Hence, embodiments herein disclose a physical layer design to make more robust existing MCSs, while being backwards compatible with said legacy MCSs. Such “backwards compatible robustification” of an MCS can be used to achieve a longer range. Note that even though a “backwards compatible robustification” is not the only solution to the problem of extending coverage, it is the chosen solution in 802.11ah, e.g. MCS10, and it is a candidate solution for a future IoT variant of 802.11 in the 2.4 GHz or 5 GHz bands, see above. Embodiments herein disclose an alternative to the 802.11ah MCS10 design which gives comparable performance, but that requires less overhead. The reduced overhead translates into increased battery life and reduced air-time occupancy. Both are highly desirable properties in IoT systems. Moreover, the proposed design enjoys the same desirable properties of backward compatibility present in the 802.11ah MCS10 design.

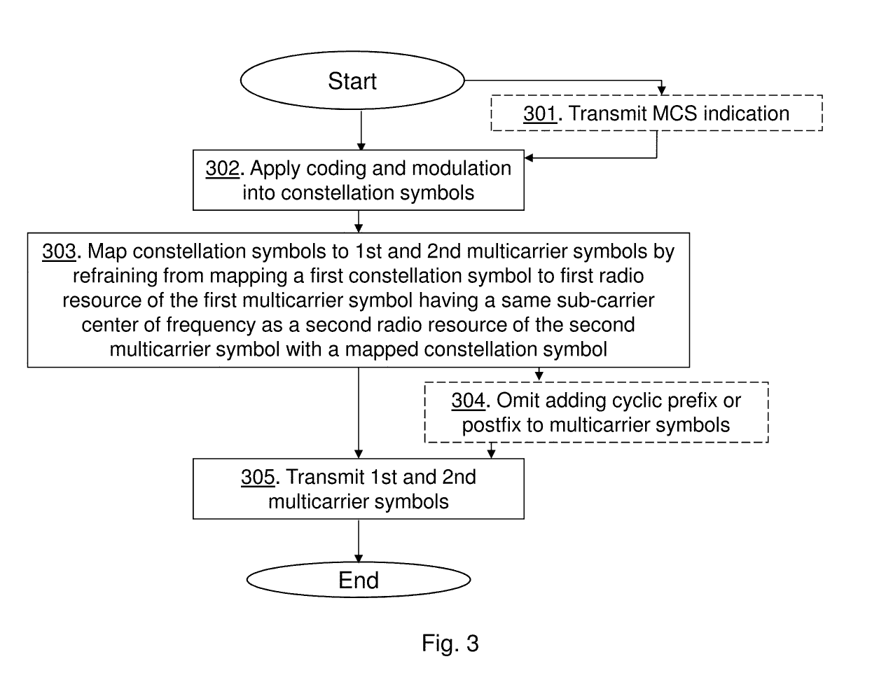

The method actions performed by the transmitting communication device 110 for transmitting data to the receiving communication device 112 in the communication network 1 supporting multicarrier modulation according to some embodiments will now be described with reference to a flowchart depicted in FIG. 3. The actions do not have to be taken in the order stated below, but may be taken in any suitable order. Actions performed in some embodiments are marked with dashed boxes. The multicarrier symbols may be OFDM symbols, Multi-Carrier Code Division Multiple Access (MC-CDMA) or similar.

Action 301. The transmitting communication device 110 may transmit, to the receiving communication device 112, a modulation and coding scheme (MCS) indication, which MCS indication indicates that the transmitting communication device 110 maps according to action 303. The MCS indication may be a value indicating the MCS with a mapping according to embodiments herein, This MCS indication may be carried in a signalling field (SIG) in a preamble of a packet of an 802.11 protocol carrying the first and second multicarrier symbol. Thus, this may be performed as a single transmission or combined with the transmission of the multicarrier symbols, see action 305, wherein the MCS indication may be comprised in a preamble or header of the data or data packet.

Action 302. The transmitting communication device 110 applies, to the data, the modulation and coding scheme forming constellation symbols. The constellation symbols may be Binary Phase Shift Keying (BPSK) modulated, QAM, or Quadrature Phase Shift Keying (QPSK) modulated and these are complex numbers.

Action 303. The transmitting communication device 110 maps the constellation symbols to radio resources of the first multicarrier symbol and to radio resources of the second multicarrier symbol. The first and second multicarrier symbols are consecutive multicarrier symbols. The transmitting communication device 110 maps the constellation symbols by refraining from mapping a constellation symbol to a first radio resource of the first multicarrier symbol having the same sub-carrier center of frequency as a second radio resource of the second multicarrier symbol with a mapped constellation symbol. The transmitting communication device 110 may map the constellation symbols to third radio resource of the second multicarrier symbol having a same sub-carrier center of frequency as fourth radio resources of the first multicarrier symbol with no constellation symbols mapped to it. Thereby the constellation symbols may be mapped in a checkered pattern over the two multicarrier symbols forming multicarrier symbols of sub-carriers with constellation symbols and with a non-padding before or after the mappedconstellation symbols. The radio resources may be a sub-band of a frequency domain e.g. a subcarrier, or a block in a time-frequency plane.

Action 304. The transmitting communication device 110 may omit adding cyclic prefix or postfix to the first and second multicarrier symbol e.g. when or after mapping the constellation symbols to the radio resources of the first multicarrier symbol and to the radio resources of the second multicarrier symbol. In prior art the cyclic prefix is appended to one OFDM symbol, or to the multicarrier symbol, as follows. First the time domain multicarrier signal is generated. This signal comprises several sub-carriers, and the phase and/or amplitude of each sub-carrier is changed or modulated according to the constellation symbols. Example: There are 4 sub-carriers in the frequency band. There are also 4 BPSK constellation symbols. Each sub-carrier is a pure tone, whose amplitude is multiplied by + or −1 according to the value of the BPSK symbols. The multicarrier signal consists of the superposition of the 4 tones. Then the cyclic pre/postfix is added to this time domain signal. However, according to embodiments herein the cyclic prefix may be omitted as the mapped constellation resources are mapped to every other multicarrier symbol, see action 303, thereby forming a zero padding like structure before or after every mapped constellation symbol. This zero padding like structure takes care of time discrepancies of receiving echoed versions of the packet.

Action 305. The transmitting communication device 110 transmits, to the receiving communication device 112, the first multicarrier symbol and the second multicarrier symbol. In some embodiments the transmitting communication device 110 is configured to transmit a multicarrier symbol with a set transmit power, the transmitting communication device 110 may then transmit the first multicarrier symbol and the second multicarrier symbol with the set transmit power. The set transmit power may e.g. be maximum transmit power, 90% of maximum transmit power or similar. The transmitting communication device 110 may have a set transmit power of 1 mW or 0 dBm, in prior art this transmit power is divided over the number of sub-carriers carrying the different constellation symbols. However, according to embodiments herein since only half, or even less in case of a higher decimation factor, of the sub-carriers carry constellation symbols, the set transmit power is divided over only half or less giving higher transmit power for each sub-carrier. This results in a longer range of the transmission and with less time occupying the communication channel as the packets are shorter.

According to embodiments herein the multicarrier modulation may be without repetition code but also a combination thereof. For example, in order to increase a transmission with 6 dB there are different options. Firstly, add a 4X repetition code according to prior art. Secondly, implement embodiments herein and decimate the sub-carriers to use by keeping only one sub-carrier out of every four sub-carriers. Thirdly, one may also combine the use of a 2X repetition code plus the decimating of sub-carrier to use, now only use every other sub-carrier. This last option is a combination of MCS10 and the decimation and results in an even more robust MCS, which may be denoted as MCS12. Given an existing MCS and a power budget, embodiments herein may be used to boost this given MCS, regardless of whether repetition coding is already used or not.

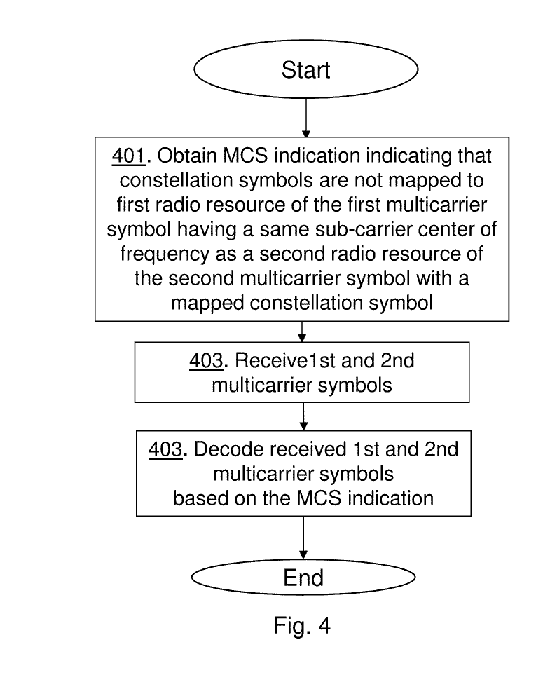

The method actions performed by the receiving communication device 112 for receiving data from the transmitting communication device 110 in the communication network 1 supporting multicarrier modulation according to some embodiments will now be described with reference to a flowchart depicted in FIG. 4.

Action 401. The receiving communication device 112 obtains the MCS indication. The MCS indication indicates that constellation symbols are mapped to radio resources of the first multicarrier symbol and to radio resources of the second multicarrier symbol, wherein the first and second multicarrier symbols are consecutive multicarrier symbols, and a constellation symbol is not mapped to the first radio resource of the first multicarrier symbol having the same sub-carrier center of frequency as the second radio resource of the second multicarrier symbol with a mapped constellation symbol. The receiving communication device 112 may obtain the modulation and coding scheme indication by receiving the modulation and coding scheme indication from the transmitting communication device 110. The receiving communication device 112 may also obtain the MCS indication during configuration, manufacturing or similarly. The modulation and coding scheme indication may be carried in the signalling field in a preamble of a packet of an 802.11 protocol carrying the first and second multicarrier symbols. The MCS indication may be a value indicating the mapping according to embodiments herein in an indexed table.

Action 402. The receiving communication device 112 receives, from the transmitting communication device 110, the first multicarrier symbol and the second multicarrier symbol. The receiving communication device 112 may receive the MCS indication and the first and the second multicarrier symbols in separated transmissions or in a single transmission, wherein the MCS indication may be comprised in a preamble or header of the data indicating e.g. MCS11.

Action 403. The receiving communication device 112 decodes the received first and second multicarrier symbols based on the received MCS indication.

The receiving communication device 112 may comprise a Zero padding OFDM receiver to perform the embodiments herein. The multicarrier modulation may be without repetition code or with repetition code.

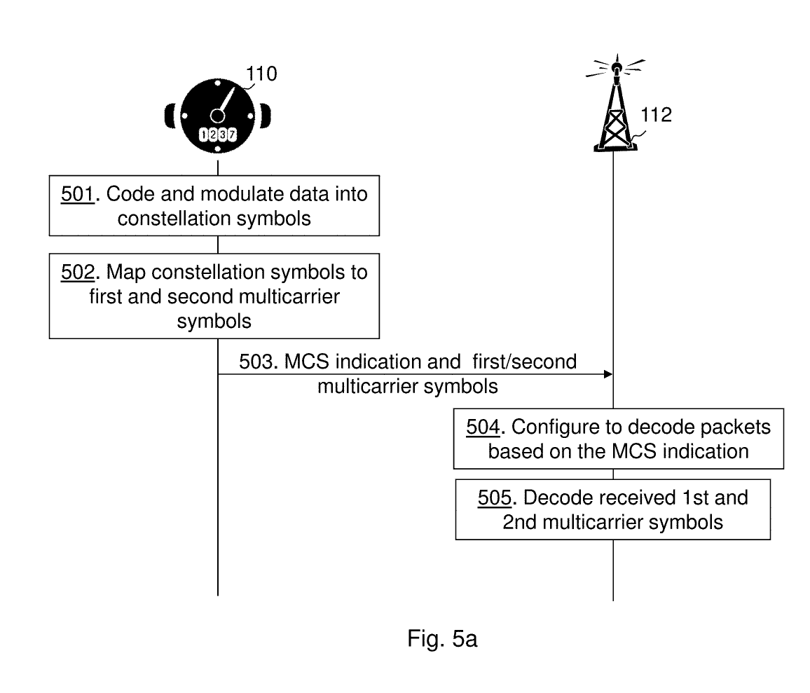

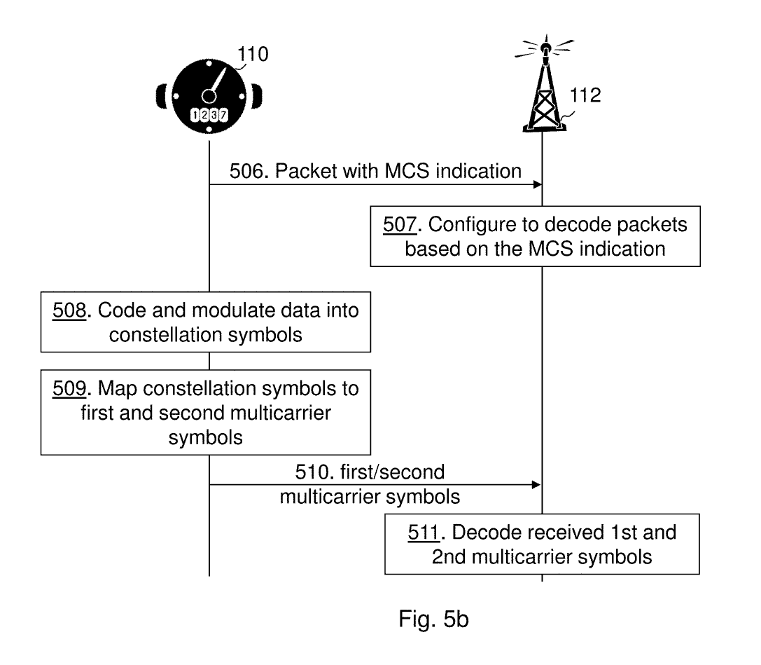

FIG. 5a is a combined flowchart and signaling scheme according to some embodiments herein, wherein the communication network 1 is exemplified as a Wi-Fi network.

Action 501. The transmitting communication device 110 initiates a transmission of data or data packets by first coding and modulating the data packets into constellation symbols, such as BPSK symbols.

Action 502. The transmitting communication device 110 then maps the constellation symbols to two consecutive multicarrier symbols, i.e. the first and second multicarrier symbols. Two consecutive multicarrier symbol meaning two multicarrier symbols directly after one another in the time domain or two multicarrier symbols adjacent in time and/or followed one another. For example, the transmitting communication device 110 maps a first constellation symbol to a sub-carrier of the second multicarrier symbol, and refrains from mapping a second constellation symbol to the same sub-carrier, or at least having the same sub-carrier center of frequency, of the first multicarrier symbol. Since this forms a zero padding of the sub-carrier of the first multicarrier symbol, the cyclic prefix (CP) is not needed to be added to the second multicarrier symbol. This results in that the packets may be shortened and thus the radio resources required to transmit the packet in the air is reduced. Hence, the transmitting communication device 110 decimates the number of radio resources available for mapping the constellation symbols to within a multicarrier symbol.

Action 503. The transmitting communication device 110 transmits the first multicarrier symbol and the second multicarrier symbol to the receiving communication device 112. The transmission is performed with the set transmit power. Since the number of radio resources, e.g. sub-carriers, with mapped constellation symbols is reduced, the set transmit power is shared over the reduced number of radio resources. Thus, each radio resource is transmitted with a higher power compared to if all the radio resources of the multicarrier symbols would carry a mapped constellation symbol. Hence, embodiments herein provide a mechanism to improve performance of the communication network in an efficient manner. The transmitting communication device 110 may transmit the first multicarrier symbol and the second multicarrier symbol with the MCS indication used. The MCS indication may signaled over the SIG field in a WiFi protocol such as 802.11ah or similar. For example, the indication may be a value, an index, indicating a certain MCS number e.g. MCS11. This value may be interpreted at the receiving communication device 112 as an indication that the mapping is performed by the transmitting communication device 110 according to embodiments herein.

Action 504. The receiving communication device 112 may then configure the reception process according to the received MCS indication. That is, the receiving communication device 112 is configured to decode packets based on the MCS indication. Hence, the received MSC indication triggers a certain decoding setup.

Action 505. The receiving communication device 112 decodes the received first and second multicarrier symbols as configured i.e. based on the received MCS indication.

FIG. 5b is a combined flowchart and signaling scheme according to some embodiments herein, wherein the communication network is exemplified as a telecommunication network such as an LTE network.

Action 506. The transmitting communication device 110 may transmit a message with the MCS indication. The MCS indication may signaled over a Downlink Control Information message. For example, may the MCS indication be a value, an index, indicating a certain MCS number e.g. MCS11. This value may be interpreted at the receiving communication device 112 as an indication that the mapping is performed by the transmitting communication device 110 according to embodiments herein.

Action 507. The receiving communication device 112, receiving the MCS indication, may then configure the reception process according to the received MCS indication. That is, the receiving communication device 112 is configured to decode packets based on the MCS indication.

Action 508. The transmitting communication device 110 then initiates transmission of the data by coding and modulating data packets into constellation symbols, such as QPSK symbols.

Action 509. The transmitting communication device 110 then maps the constellation symbols to two consecutive, or adjacent in time, multicarrier symbols, i.e. the first and second multicarrier symbols. For example, the transmitting communication device 110 maps a first constellation symbol to a sub-carrier of the second multicarrier symbol, and refrains from mapping a second constellation symbol to the same sub-carrier, or at least having the same sub-carrier center of frequency, of the first multicarrier symbol. Since this forms a zero padding of the sub-carrier of the first multicarrier symbol, the CP is not needed to be added to the second multicarrier symbol. This results in that the packets may be shortened and thus the radio resources required to transmit the packet in the air is reduced. Hence, the transmitting communication device 110 decimates the number of radio resources available for mapping the constellation symbols to, within a multicarrier symbol.

Action 510. The transmitting communication device 110 transmits the first multicarrier symbol and the second multicarrier symbol to the receiving communication device 112. The transmission is performed with the set transmit power. Since the number of radio resources, e.g. sub-carriers, with mapped constellation symbols is reduced, the set transmit power is shared over the reduced number of radio resources. Thus, each radio resource is transmitted with a higher power compared to if all the radio resources of the multicarrier symbols would carry a mapped constellation symbol. Hence, embodiments herein provide a mechanism to improve performance of the communication network 1 in an efficient manner.

Action 511. The receiving communication device 112 decodes the received first and second multicarrier symbols as configured i.e. based on the received MCS indication.

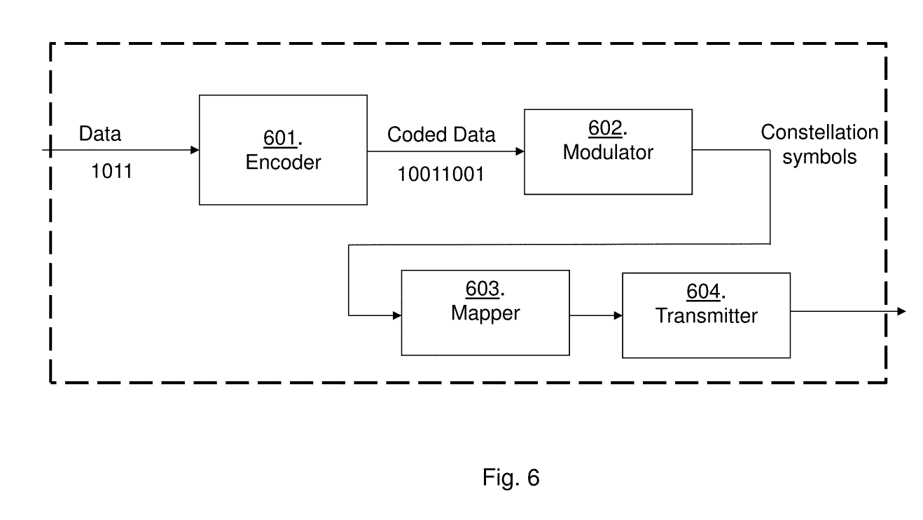

A block diagram depicting a process according to embodiments herein is exemplified in FIG. 6. The transmitting communication device 110 transmits data to the receiving communication device 112, e.g. a bit sequence of 1011.

The transmitting communication device 110 may comprise an encoder 601 with a codec coding or convolutional coding, coding the bit sequence to a coded bit sequence or data e.g. 10011001. The transmitting communication device 110 may further comprise a modulator 602 performing a modulation of the coded data forming constellation symbols of the coded data. E.g. the modulator may perform phase shift keying such as BPSK or QPSK forming BPSK symbols or QPSK symbols, respectively. The transmitting communication device 110 may also comprise a mapper 603. The mapper 603 is configured to map the constellation symbols over the first and second multicarrier symbols according to embodiments herein. For example, the mapper 603 may map one or more constellation symbols to an initial sub-carrier of the second multicarrier symbol and may refrain from mapping one or more constellation symbols to a corresponding sub-carrier of the first multicarrier symbol. Correspondingly, the mapper 603 may map one or more constellation symbols to an initial sub-carrier of the first multicarrier symbol and may refrain from mapping one or more constellation symbols to a corresponding sub-carrier of the second multicarrier symbol. Furthermore, the transmitting communication device 110 may comprise a transmitter 604 configured with e.g. a maximum power. The transmitter 604 transmits the multicarrier symbols with the mapped constellation symbols. Each multicarrier symbol may e.g. be transmitted with the maximum power. Hence, each constellation symbol is transmitted with an increased power as the number of transmitted constellation symbols is reduced but the set transmit power is constant.

According to embodiments herein, the transmitting communication device 110 decimates the available radio resources by a decimation factor K, and boost the power of the remaining radio resources by a factor of 10 log 10(K) dB. With this combination of decimation and boosting, the total signal power is conserved. Moreover, the decimation is performed in such a way that radio resources carrying constellation symbols and being adjacent in time are prevented from having the same sub-carrier center of frequency. Error! Reference source not found. gives an example of an allocation of radio resources of a first OFDM symbol, OFDM symbol #N, and a second OFDM symbol, OFDM symbol #N+1 that is allowed. Frequencies or sub-carriers are defined along a vertical axis and time is defined along a horizontal axis. In addition, the cyclic prefix may be eliminated. As stated above, the cyclic prefix can be eliminated because a mapping pattern according to the embodiments herein introduces a form of zero padding to the multicarrier symbols. Zero padded OFDM is an attractive alternative to cyclic prefix OFDM (CP-OFDM). The mapping pattern disclosed in embodiments herein eliminates the overhead due to the omitting of the cyclic prefix. Radio resources with mapped constellation symbols are marked with a cross diagonal striped pattern and may be boosted with e.g. 3 dB. The radio resources with no mapped constellation symbols also called null sub-carriers are white marked.

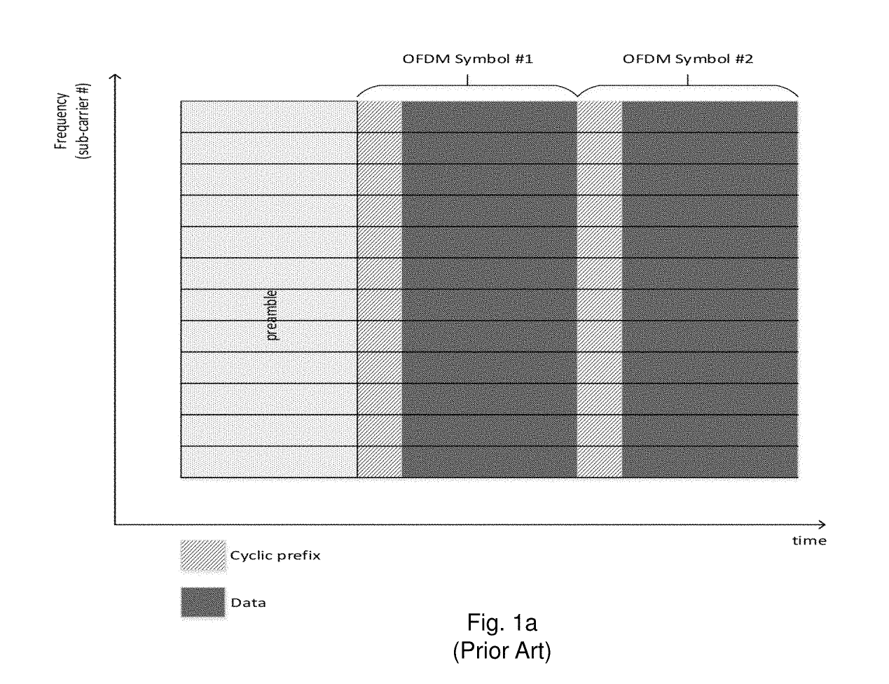

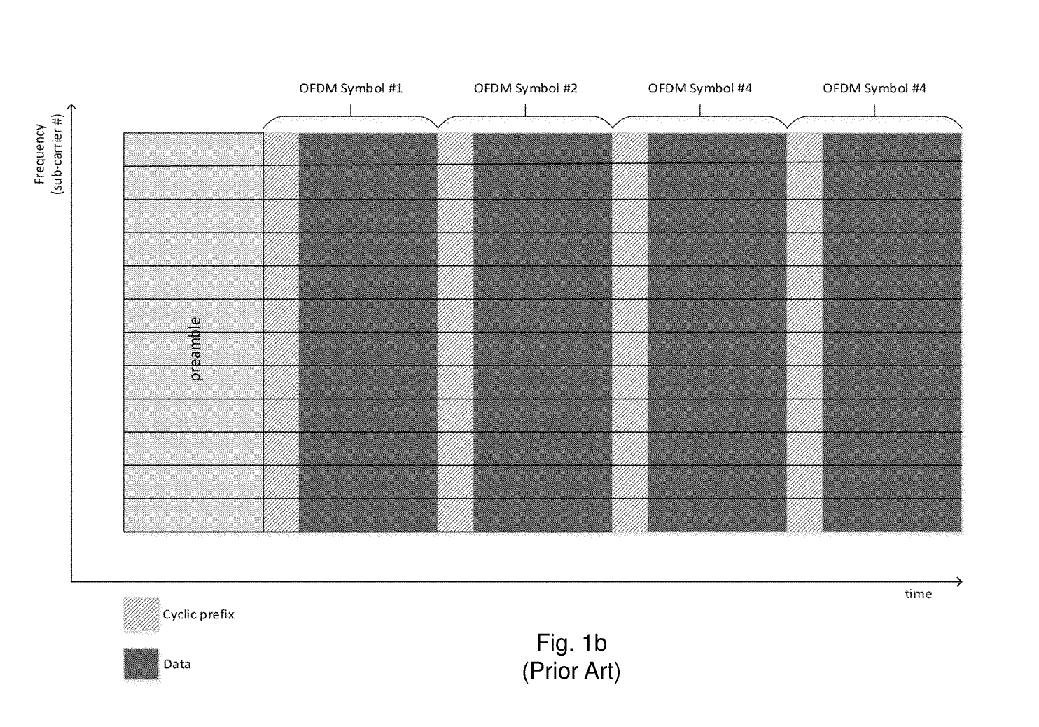

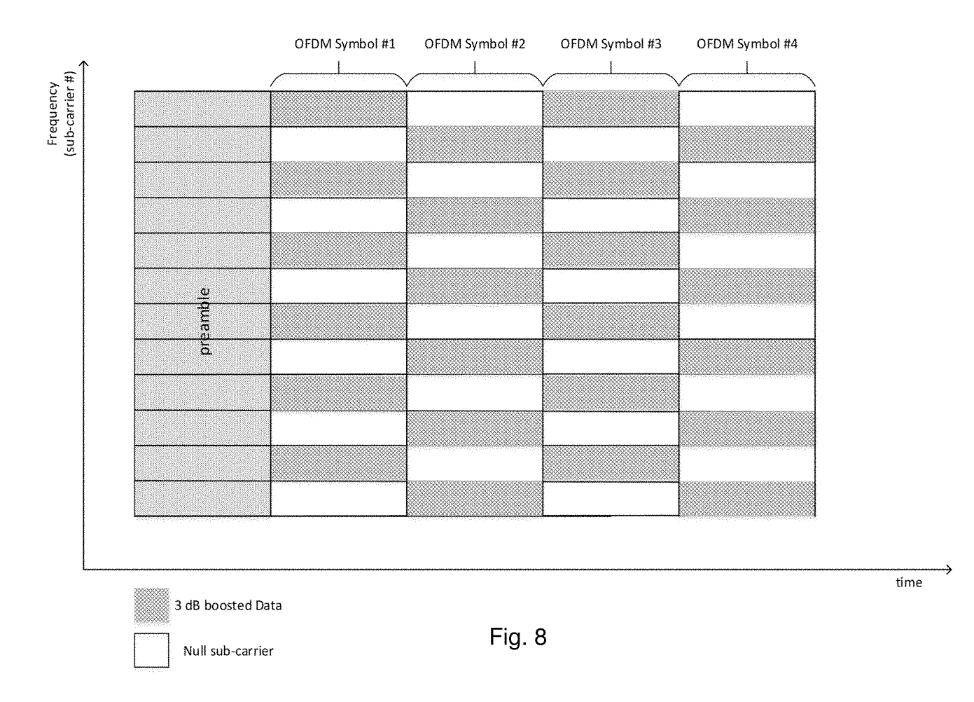

FIG. 8 illustrates a scenario where embodiments herein apply the decimation factor with a value of 2, i.e. K=2. Frequencies or sub-carriers are defined along a vertical axis and time is defined along a horizontal axis. FIG. 8 shows how the packet format shown in FIG. 1a can be made more robust. The channel code and the modulation order, e.g. BPSK, used in FIG. 1a are kept, but the mapping the constellation symbols to the radio resources, e.g. sub-carriers, is different. The number of active radio resources is equal in both figures, but each radio resource may be boosted by 3 dB in FIG. 8. Notice also that the cyclic prefix has been eliminated. The null sub-carriers in a given OFDM symbol act as zero padding for the active sub-carriers in the following OFDM symbol. The preamble of the packet is marked with a dotted pattern, radio resources with mapped constellation symbols are marked with a cross diagonal striped pattern and may be boosted with e.g. 3 dB. The radio resources with no mapped constellation symbols also called null sub-carriers are white marked.

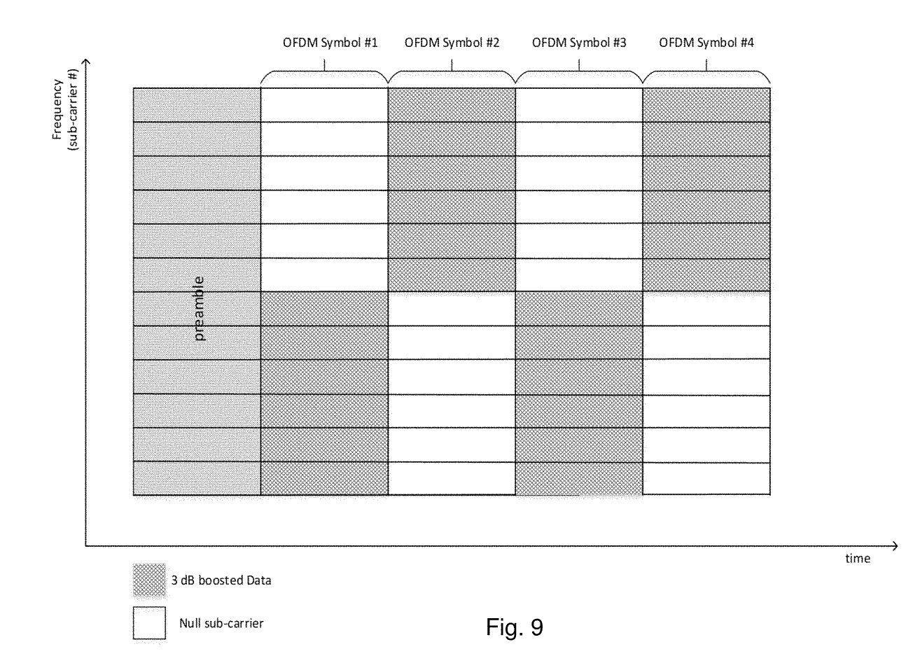

FIG. 9 illustrates a scenario where embodiments herein apply the decimation factor with a value of 2, i.e. K=2. Frequencies or sub-carriers are defined along a vertical axis and time is defined along a horizontal axis. It also shows how to make more robust the packet format shown in FIG. 1a. The channel code and the modulation order, e.g. BPSK, used in Error! Reference source not found.a are kept, but the mapping the constellation symbols to sub-carriers is different. The number of active radio resources is equal in both figures, but each radio resource has been boosted by 3 dB in FIG. 9. Notice also that the cyclic prefix has been eliminated. The null sub-carriers in a given OFDM symbol act as zero padding for the active sub-carriers in the following OFDM symbol. The preamble of the packet is marked with a dotted pattern, radio resources with mapped constellation symbols are marked with a cross diagonal striped pattern and may be boosted with e.g. 3 dB. The radio resources with no mapped constellation symbols, also called null sub-carriers, are white marked.

Observe that the transmission format shown in FIG. 9 is in fact a modification of a Zero Padding (ZP)-OFDM, with alternating frequency bands. By alternating the frequency bands the overhead is eliminated.

The transmission formats shown in FIG. 8 and FIG. 9 may employ the same channel code, e.g. a binary convolutional code, and modulation symbol mapping, e.g. PSK/QAM, as the transmission format of FIG. 1a. This gives the packet format disclosed in embodiments herein backward compatibility with existing MCSs in multicarrier systems.

Embodiments herein lead to shorter packets in comparison with the methodology used in 802.11ah MCS10 by not needing to use cyclic prefix or postfix. The link performance of 802.11 systems is dependent on the packet length. For any given MCS, shorter packets yield better performance.

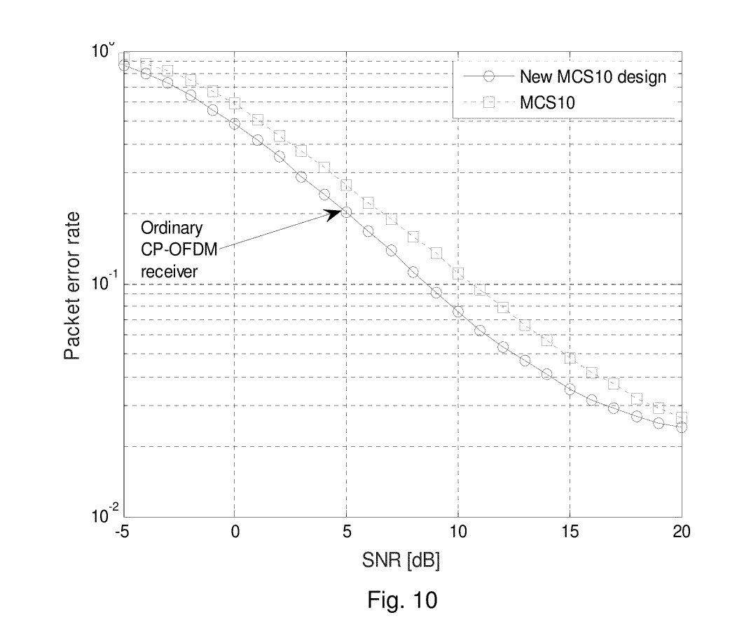

Error! Reference source not found. shows that the solution proposed in embodiments herein outperforms MCS10 in a fading channel, even though the receiver is highly suboptimal, since an ordinary CP-OFDM receiver has been employed. The reason for the gain is that the packet formatted according to embodiments herein is shorter than a packet length of the MCS10 benchmark. Packet error rate is defined along a vertical axis and Signal to Noise Ratio (SNR) is defined along a horizontal axis. The outcome of the embodiments herein is defined along a curve marked with circles and outcome of conventional MCS10 is defined along a curve marked with squares. FIG. 10 shows that embodiments herein have a lower packet error rate than using conventional MCS10.

The proposed design according to embodiments herein reduces a packet length by 25% in comparison to MCS10. This means that the power consumption is reduced by 25% at both the transmitting communication device 110 and at the receiving communication device 112. Shorter packets also yield improved link performance. Alternatively, the throughput can be increased, since more data can be packed in the time available for transmission. For example, a life of a battery-powered device with a lifetime of 4 years can be extended to up to 5 years. The embodiments herein may be applied to future variants of 802.11 devices geared towards IoT in the 2.4 GHz or 5 GHz frequency bands.

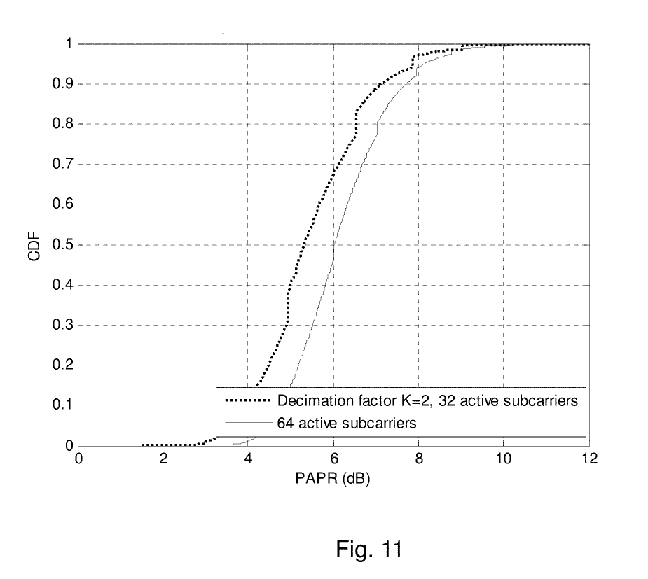

Some embodiments herein yield signals with lower Peak to Average Power Ratio (PAPR) than conventional OFDM, as shown in FIG. 11. Moreover, embodiments herein also yield a packet format more robust to large delay spreads than a conventional CP-OFDM format, since the effective length of the zero padding is one full OFDM symbol. Decimation of the radio resources may thus also have a beneficial effect on the PAPR of the transmitted signal. FIG. 11 shows outcome of an example where decimation using the “chessboard” pattern of FIG. 8 reducing the PAPR. Cumulative Distribution Function (CDF) is defined along a vertical axis and PAPR is defined along a horizontal axis. FIG. 11 is an example of cumulative distribution of PAPR for OFDM symbols with 64 sub-carriers. The continuous line shows the case where all 64 sub-carriers are active, the dotted line shows the case where 32 sub-carriers are active and 32 sub-carriers are nulled. Low PAPR is a desirable property because it results in a longer range of the transmission, and embodiments herein lower the PAPR when compared with using a conventional MCS.

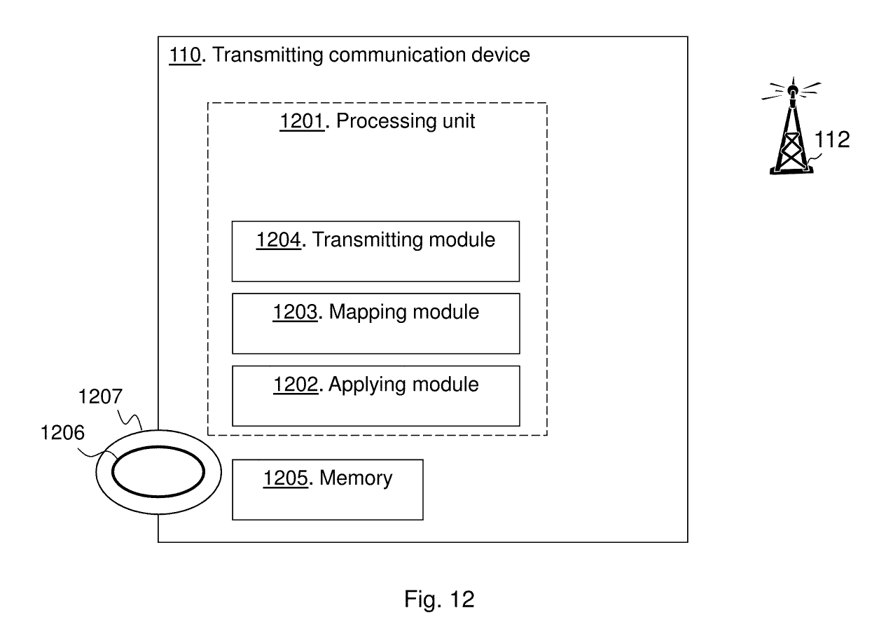

FIG. 12 is a block diagram depicting the transmitting communication device 110 for transmitting data to the receiving communication device 112 in the communication network 1 supporting multicarrier modulation. The multicarrier modulation may be without repetition code.

The transmitting communication device 110 is configured to apply, to the data, the modulation and coding scheme forming constellation symbols.

The transmitting communication device 110 is further configured to map the constellation symbols to radio resources of the first multicarrier symbol and to radio resources of the second multicarrier symbol, wherein the first and second multicarrier symbols are consecutive multicarrier symbols. The transmitting communication device is also configured to refrain from mapping a constellation symbol to the first radio resource of the first multicarrier symbol having the same sub-carrier center of frequency as the second radio resource of the second multicarrier symbol with a mapped constellation symbol. The transmitting communication device 110 may further be configured to map a constellation symbol to the third radio resource of the second multicarrier symbol having the same sub-carrier center of frequency as the fourth radio resource of the first multicarrier symbol with no constellation symbols mapped to it. The radio resources may be a sub-band of a frequency domain or a block in a time-frequency plane.

The transmitting communication device 110 may further be configured to omit adding cyclic prefix or postfix to the first multicarrier symbol and the second multicarrier symbol e.g. when or after mapping the constellation symbols to the radio resources of the first multicarrier symbol and to the radio resources of the second multicarrier symbol.

The transmitting communication device 110 is further configured to transmit, to the receiving communication device 112, the first multicarrier symbol and the second multicarrier symbol. The transmitting communication device 110 may further be configured to transmit a multicarrier symbol with a set transmit power, and may further be configured to transmit the first multicarrier symbol and the second multicarrier symbol with the set transmit power. I.e. the first multicarrier symbol may be transmitted with the set power and the second multicarrier symbol may be transmitted with the set power.

The transmitting communication device 110 may further be configured to transmit, to the receiving communication device 112, the MCS indication, which MCS indication indicates that the transmitting communication device 110 is configured according to embodiments herein. The transmitting communication device 110 may be configured to transmit the MCS indication in a signalling field in a preamble of a packet of an 802.11 protocol carrying the first and second multicarrier symbols.

The transmitting communication device 110 may comprise a processing unit 1201, e.g. one or more processors configured to perform the method herein.

The transmitting communication device 110 may comprise an applying module 1202. The processing unit 1201 and/or the applying module 1202 may be configured to apply, to the data, the modulation and coding scheme forming constellation symbols.

The transmitting communication device 110 may comprise a mapping module 1203. The processing unit 1201 and/or the mapping module 1203 may be configured to map the constellation symbols to radio resources of a first multicarrier symbol and to radio resources of a second multicarrier symbol, wherein the first and second multicarrier symbols are consecutive multicarrier symbols. The processing unit 1201 and/or the mapping module 1203 may be configured to refrain from mapping a constellation symbol to a first radio resource of the first multicarrier symbol having a same sub-carrier center of frequency as a second radio resource of the second multicarrier symbol with a mapped constellation symbol. The processing unit 1201 and/or the mapping module 1203 may be configured to map a constellation symbol to a third radio resource of the second multicarrier symbol having a same sub-carrier center of frequency as a fourth radio resource of the first multicarrier symbol with no constellation symbols mapped to it. The processing unit 1201 and/or the mapping module 1203 may be configured to omit adding cyclic prefix or postfix to the first multicarrier symbol and the second multicarrier symbol e.g. when or after mapping the constellation symbols to the radio resources of the first multicarrier symbol and to the radio resources of the second multicarrier symbol.

The transmitting communication device 110 may comprise a transmitting module 1204. The processing unit 1201 and/or the transmitting module 1204 may be configured to transmit, to the receiving communication device 112, the first multicarrier symbol and the second multicarrier symbol. The processing unit 1201 and/or the transmitting module 1204 may be configured to transmit a multicarrier symbol with a set transmit power, and may further be configured to transmit the first multicarrier symbol and the second multicarrier symbol with the set transmit power. The processing unit 1201 and/or the transmitting module 1204 may be configured to transmit, to the receiving communication device 112, the MCS indication, which MCS indication indicates that the transmitting communication device 110 is configured according to embodiments herein. The processing unit 1201 and/or the transmitting module 1204 may be configured to transmit the MCS indication in the signalling field in the preamble of the packet of an 802.11 protocol carrying the first and second multicarrier symbol.

The transmitting communication device 110 may comprise a memory 1205. The memory 1205 comprises one or more units to be used to store data on, such as MCS indication, coding and modulation, mapping schemes, information regarding radio resources, information regarding multicarrier symbols, applications to perform the methods disclosed herein when being executed, and similar.

The methods according to the embodiments described herein for the transmitting communication device 110 are respectively implemented by means of e.g. a computer program 1206 or a computer program product, comprising instructions, i.e., software code portions, which, when executed on at least one processor, cause the at least one processor to carry out the actions described herein, as performed by the transmitting communication device 110. The computer program 1206 may be stored on a computer-readable storage medium 1207, e.g. a disc or similar. The computer-readable storage medium 1207, having stored thereon the computer program, may comprise the instructions which, when executed on at least one processor, cause the at least one processor to carry out the actions described herein, as performed by the transmitting communication device 110. In some embodiments, the computer-readable storage medium may be a non-transitory computer-readable storage medium.

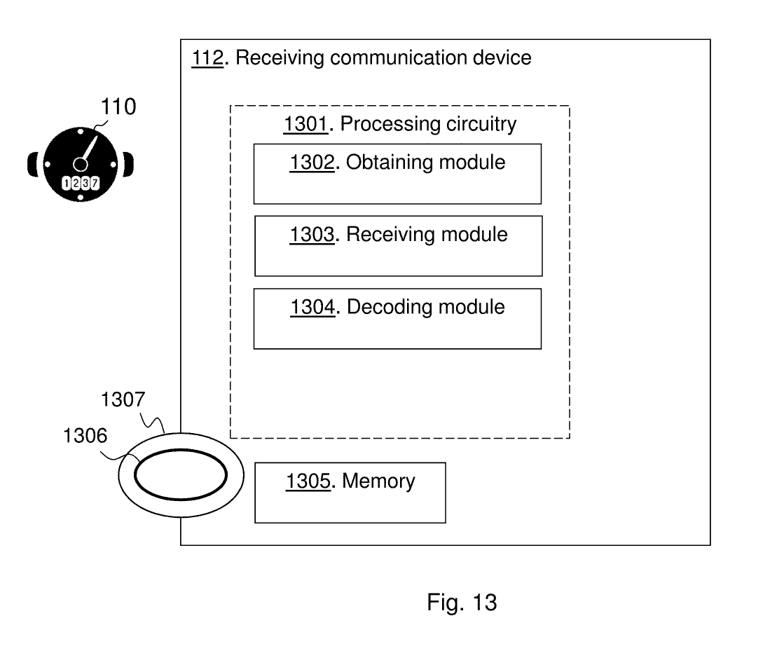

FIG. 13 is a block diagram depicting the receiving communication device 112 for receiving data from the transmitting communication device 110 in the communication network 1 supporting multicarrier modulation. The multicarrier modulation may be without repetition code.

The receiving communication device 112 is configured to obtain the MCS indication, indicating that constellation symbols are mapped to radio resources of the first multicarrier symbol and to radio resources of the second multicarrier symbol. The first and second multicarrier symbols are consecutive multicarrier symbols, and a constellation symbols is not mapped to the first radio resource of the first multicarrier symbol having the same sub-carrier center of frequency as the second radio resource of the second multicarrier symbol with a mapped constellation symbol. The receiving communication device 112 may be configured to obtain the MCS indication by receiving the modulation and coding scheme indication from the transmitting communication device 110. The MCS indication may be carried in the signalling field in the preamble of the packet of an 802.11 protocol carrying the first multicarrier symbol and the second multicarrier symbol.

The receiving communication device 112 is further configured to receive, from the transmitting communication device 110, the first multicarrier symbol and the second multicarrier symbol.

The receiving communication device 112 is also configured to decode the received first and second multicarrier symbols based on the received MCS indication.

The receiving communication device 112 may comprise a Zero padding OFDM receiver to decode the received first and second multicarrier symbols.

The receiving communication device 112 may comprise a processing unit 1301, e.g. one or more processors configured to perform the method herein.

The receiving communication device 112 may comprise an obtaining module 1302. The processing unit 1301 and/or the obtaining module 1302 may be configured to obtain the MCS indication, indicating that constellation symbols are mapped to radio resources of the first multicarrier symbol and to radio resources of the second multicarrier symbol. The first and second multicarrier symbols are consecutive multicarrier symbols, and a constellation symbol is not mapped to the first radio resource of the first multicarrier symbol having the same sub-carrier center of frequency as the second radio resource of the second multicarrier symbol with a mapped constellation symbol. The processing unit 1301 and/or the obtaining module 1302 may be configured to obtain the MCS indication by receiving the modulation and coding scheme indication from the transmitting communication device 110. The MCS indication may be carried in the signalling field in the preamble of the packet of an 802.11 protocol carrying the first multicarrier symbol and the second multicarrier symbol.

The receiving communication device 112 may comprise a receiving module 1303. The processing unit 1301 and/or the receiving module 1303 may be configured to receive, from the transmitting communication device 110, the first multicarrier symbol and the second multicarrier symbol.

The receiving communication device 112 may comprise a decoding module 1304. The processing unit 1301 and/or the decoding module 1304 may be configured to decode the received first and second multicarrier symbols based on the received MCS indication.

The receiving communication device 112 may comprise a memory 1305. The memory 1305 comprises one or more units to be used to store data on, such as MCS indication, decoders, demapping schemes, information regarding radio resources, information regarding multicarrier symbols, applications to perform the methods disclosed herein when being executed, and similar.

The methods according to the embodiments described herein for the receiving communication device 112 are respectively implemented by means of e.g. a computer program 1306 or a computer program product, comprising instructions, i.e., software code portions, which, when executed on at least one processor, cause the at least one processor to carry out the actions described herein, as performed by the receiving communication device 112. The computer program 1306 may be stored on a computer-readable storage medium 1307, e.g. a disc or similar. The computer-readable storage medium 1307, having stored thereon the computer program, may comprise the instructions which, when executed on at least one processor, cause the at least one processor to carry out the actions described herein, as performed by the receiving communication device 112. In some embodiments, the computer-readable storage medium may be a non-transitory computer-readable storage medium.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a communication device, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the inventive apparatus and techniques taught herein are not limited by the foregoing description and accompanying drawings. Instead, the embodiments herein are limited only by the following claims and their legal equivalents.

1. A method performed by a transmitting communication device for transmitting data to a receiving communication device in a communication network supporting multicarrier modulation; the method comprising:
applying, to the data, a modulation and coding scheme forming constellation symbols;
mapping the constellation symbols to radio resources of a first multicarrier symbol and to radio resources of a second multicarrier symbol, wherein the first and second multicarrier symbols are consecutive multicarrier symbols, and the mapping comprises refraining from mapping a constellation symbol to a first radio resource of the first multicarrier symbol having a same sub-carrier center of frequency as a second radio resource of the second multicarrier symbol with a mapped constellation symbol; and
transmitting the first multicarrier symbol and the second multicarrier symbol to the receiving communication device.

2. A method according to claim 1, further comprising
omitting adding cyclic prefix or postfix to the first multicarrier symbol and the second multicarrier symbol.

3. A method according to claim 1, wherein the mapping comprises mapping a constellation symbol to a third radio resource of the second multicarrier symbol having a same sub-carrier center of frequency as a fourth radio resource of the first multicarrier symbol with no constellation symbols mapped to it.

4. A method according to claim 1, wherein the transmitting communication device is configured to transmit a multicarrier symbol with a set transmit power, and the transmitting is performed with the set transmit power.

5. (canceled)

6. A method according to claim 1, further comprising
transmitting, to the receiving communication device a modulation and coding scheme indication, which modulation and coding scheme indication indicates that the transmitting communication device performs mapping the constellation symbols.

7.-8. (canceled)

9. A method performed by a receiving communication device for receiving data from a transmitting communication device in a communication network supporting multicarrier modulation; the method comprising:
obtaining a modulation and coding scheme indication, indicating that constellation symbols are mapped to radio resources of a first multicarrier symbol and to radio resources of a second multicarrier symbol, wherein the first and second multicarrier symbols are consecutive multicarrier symbols, and a constellation symbol is not mapped to a first radio resource of the first multicarrier symbol having a same sub-carrier center of frequency as a second radio resource of the second multicarrier symbol with a mapped constellation symbol;
receiving, from the transmitting communication device, the first multicarrier symbol and the second multicarrier symbol; and
decoding the received first and second multicarrier symbols based on the received modulation and coding scheme indication.

10. A method according to claim 9, wherein the multicarrier modulation is without repetition code.

11.-12. (canceled)

13. A transmitting communication device for transmitting data to a receiving communication device in a communication network supporting multicarrier modulation, wherein the transmitting communication device comprises:
at least one processor; and
memory coupled with the at least one processor, wherein the memory includes instructions stored therein, wherein the instructions when executed on the at least one processor cause the at least one processor to,
apply, to the data, a modulation and coding scheme forming constellation symbols;
map the constellation symbols to radio resources of a first multicarrier symbol and to radio resources of a second multicarrier symbol, wherein the first and second multicarrier symbols are consecutive multicarrier symbols, and also being configured to refrain from mapping a constellation symbol to a first radio resource of the first multicarrier symbol having a same sub-carrier center of frequency as a second radio resource of the second multicarrier symbol with a mapped constellation symbol, and to
transmit, to the receiving communication device, the first multicarrier symbol and the second multicarrier symbol.

14. A transmitting communication device according to claim 13, wherein the instructions when executed on the at least one processor further cause the at least one processor to,
omit adding cyclic prefix or postfix to the first multicarrier symbol and the second multicarrier symbol.

15. A transmitting communication device according to claim 13, wherein the instructions when executed on the at least one processor further cause the at least one processor to,
map a constellation symbol to a third radio resource of the second multicarrier symbol having a same sub-carrier center of frequency as a fourth radio resource of the first multicarrier symbol with no constellation symbols mapped to it.

16. A transmitting communication device according to claim 13, wherein the instructions when executed on the at least one processor further cause the at least one processor to,
transmit a multicarrier symbol with a set transmit power, and further being configured to transmit the first multicarrier symbol and the second multicarrier symbol with the set transmit power.

17. A transmitting communication device according to claim 13, wherein the radio resources are a sub-band of a frequency domain or a block in a time-frequency plane.

18. A transmitting communication device according to claim 13, wherein the instructions when executed on the at least one processor further cause the at least one processor to,
transmit, to the receiving communication device, a modulation and coding scheme indication, which modulation and coding scheme indication indicates that the transmitting communication device performs mapping the constellation symbols.

19. A transmitting communication device according to claim 18, wherein the instructions when executed on the at least one processor further cause the at least one processor to,
transmit the modulation and coding scheme indication in a signalling field in a preamble of a packet of an 802.11 protocol carrying the first and second multicarrier symbol.

20. A transmitting communication device according to claim 13, wherein the multicarrier modulation is without repetition code.

21. A receiving communication device for receiving data from a transmitting communication device in a communication network supporting multicarrier modulation, wherein the receiving communication device is comprises:
at least one processor; and
memory coupled with the at least one processor, wherein the memory includes instructions stored therein, wherein the instructions when executed on the at least one processor cause the at least one processor to,
obtain a modulation and coding scheme indication, indicating that constellation symbols are mapped to radio resources of a first multicarrier symbol and to radio resources of a second multicarrier symbol, wherein the first and second multicarrier symbols are consecutive multicarrier symbols, and a constellation symbol is not mapped to a first radio resource of the first multicarrier symbol having a same sub-carrier center of frequency as a second radio resource of the second multicarrier symbol with a mapped constellation symbol,
receive, from the transmitting communication device, the first multicarrier symbol and the second multicarrier symbol, and
decode the received first and second multicarrier symbols based on the received modulation and coding scheme indication.

22. A receiving communication device according to claim 21, comprising a Zero padding Orthogonal Frequency Division Multiplexing, OFDM, receiver to decode the received first and second multicarrier symbols.

23. A receiving communication device according to claim 21, wherein the multicarrier modulation is without repetition code.

24. A receiving communication device according to claim 21, wherein the instructions when executed on the at least one processor further cause the at least one processor to,
obtain the modulation and coding scheme indication by receiving the modulation and coding scheme indication from the transmitting communication device.

25. A receiving communication device according to claim 24, wherein the modulation and coding scheme indication is carried in a signalling field in a preamble of a packet of an 802.11 protocol carrying the first multicarrier symbol and the second multicarrier symbol.

26.-27. (canceled)
